(19) United States
(12) Patent Application Publication
(10) Pub. No.: US 2024/0102325 A1
(43) Pub. Date: Mar. 28, 2024

(54) Door Barricade with Single Motion Egress System

(71) Applicant: RHINOWARE CONNECT, LLC, Durham, NC (US)

(72) Inventors: Michael Angelo Silvani, Jr., Eagleswood, NJ (US); Ernest Lawrence Johnson, III, Jacksonville, NC (US)

(73) Assignee: RHINOWARE CONNECT, LLC, Durham, NC (US)

(21) Appl. No.: 18/504,483

(22) Filed: Nov. 8, 2023

Related U.S. Application Data
(63) Continuation-in-part of application No. 17/575,206, filed on Jan. 13, 2022, now abandoned.
Application No. 17/575,206 is a continuation-in-part of application No. 16/524,978, filed on Jul. 29, 2019, now abandoned.
Application No. 16/524,978 is a continuation-in-part of application No. PCT/US19/13951, filed on Jan. 17, 2019.

(51) Int. Cl. E05C 1/06; E05C 1/00

(52) U.S. Cl. CPC E05C 1/06; E05C 1/004

(57) ABSTRACT

An improved door barricade system for use during an emergency situation, having a pivoting locking arm which drops into a floor hole to lock a barricade in place using a single motion egress system to unlock and open a door simultaneously.

This application is a Continuation-in-Part of U.S. Non-Provisional application Ser. No. 16/524,978 filed on Jul. 29, 2019 now abandoned and of U.S. Non-Provisional application Ser. No. 17/575,206 filed on Jan. 13, 2022. This application is also a CIP of PCT application PCT/US19/43951 filed on Jul. 29, 2019. U.S. Pat. No. 10,214,948 B2, in the name of Richmond, issued on Feb. 26, 2019, U.S. Pat. No. 10,316,556 B2, in the name of Richmond, issued on Jun. 11, 2019, U.S. Pat. No. 6,471,264 B1, in the name of Ryan, issued on Oct. 29, 2002, and Publication number US 2009/0322473 A1, in the name of Aliferis, et al., published on Dec. 31, 2009, are relevant and incorporated herein by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a door safety barricade system. In particular, the present invention relates to a system for barricading a door from the inside during an emergency situation wherein egress and opening the barricade are done in one motion and also usable by disabled individuals and the like to lock or unlock the barricade without opening the door.

### Description of Related Art

The more frequent occurrence of intruders in schools, businesses, and government facilities has highlighted safety needs for people working at or using such facilities, such as students in a school. Schools and other facilities are constantly attempting to prevent an intruder from entering classrooms, offices, and the like. In an intruder situation, many places go into a lockdown situation where people remain sheltered in place. First responders can take an average of 18 minutes before they reach the situation if no security personnel is readily present and, as such, keeping the occupants of a room safe from entry by an intruder is critical while waiting for first responders. An effective door barricade is needed to protect the room occupants and allow time for first responders to arrive.

In schools, and most buildings, there are many kinds of doors. Some swing outward, while others swing inwards. In addition, some doors are double doors that open in the middle of the two doors and swing either in or out. In addition, many schools, and the like, do not allow door locks on the interior of the door. Where there are door locks, they require going outside of the classroom, into the hallway and into the line of danger in order to utilize the door lock.

Many rooms in these situations have a window in the door, or next to the door, making it relatively easy to break the window and reach in to access the door knob and unlock and open the door.

The devices attempting to deal with the situation have used various approaches. There are devices that attach to the door jamb, but the door jamb can be broken and the door can still easily be kicked in. There are a number of devices that attach between the inside face of the door and the floor, but they all have a removable pin, key, or the like, which can be lost or stolen, rendering the device useless in an emergency.

One problem with the current door barricades is the lack of easy access and use by disabled individuals. Floor based barricades often require bending over to engage or disengage the barricade with or without opening the door, and many disabled individuals cannot bend over.

A door barricade that can be utilized in commercial situations (like schools and offices) is described in U.S. Pat. No. 10,214,948 B2, in the name of Richmond, issued on Feb. 26, 2019, U.S. Pat. No. 10,316,556 B2, in the name of Richmond, issued on Jun. 11, 2019, U.S. Pat. No. 6,471,264 B1, in the name of Ryan, issued on Oct. 29, 2002, and Publication number US 2009/0322473 A1, in the name of Aliferis, et al., published on Dec. 31, 2009, are relevant and incorporated herein by reference. While the aforementioned door barricades can be engaged in a single motion, if a person wishes to leave the room, then there is a two-step process for egress. First, one must unlock the door barricade and second, one must engage the door lever to exit. While this is a relatively quick way to exit, many jurisdictions require a single motion egress by code when used in commercial situations. It also does not disclose a separate handicap release lever, which avoids a disabled person from having to bend over.

### BRIEF SUMMARY OF THE INVENTION

The present invention relates to an improved door barricade mounted between the interior face of the door and the adjacent floor that succeeds in overcoming the problems of the previous devices by providing a one motion egress (both open a door and barricade simultaneously), and also a separate means to be used by disabled individuals to engage and disengage the barricade without opening the door. It allows for an individual to instantly barricade the door and in one motion, disengage the barricade and open the door, and barricade simultaneously leaving without the need to bend over. The door barricade can be disengaged and the door opened on doors with door handles (all school and commercial buildings have lever type door handles in the US), and the barricade can be positioned, in one embodiment, about 45 inches above the floor to open or close the barricade.

Accordingly, the present invention relates to a door barricade system for a door having an interior face and an exterior face, wherein the door barricade is mounted for use on the door's interior face, which locks into an adjacent floor and has a straight vertical bolt having a lowered position when the door barricade is locked, wherein the vertical bolt is capable of moving up to an upper position to unlock the door barricade, the system having a dual cable system so the door can be unlocked and locked without opening the door comprising:
a) an open-close cable on the interior face of the door, a top portion of the open-close cable having a handle and a bottom portion of the open-close cable connected to a top position of the straight vertical bolt which, when engaged, moves the door barricade from a locked, closed door position to an unlocked, open door position or vice versa without opening the door; and
b) a door handle having a back plate, which rotates with the door handle for opening and closing the door, the door handle having a cable associated with the door handle, the cable having a top and bottom portion wherein the top portion is connected to the back plate and the bottom portion of the cable is connected to a top portion of the straight vertical bolt in a manner such that engaging the door handle to open the door causes the door handle cable to move the door to an unlocked position, the cable wrapping around the back plate, which opens the door and unlocks the barricade by lifting the vertical bolt to an upper unlocked position.

### BRIEF DESCRIPTION OF THE DRAWINGS

FIG. 1a is a perspective view of the door barricade in a closed (locked) position with the cable wrapped around the back plate.

FIG. 1b is a perspective view of the present invention in the open (unlocked) position after the opening device has been activated.

FIG. 2 is a perspective view showing a steel plate mounted on the exterior face of the door of the present invention.

FIGS. 3a and 3b are perspective views of the lever cam and mortise cam of the present invention, respectively.

FIG. 3c is a perspective view wherein the cable is attached to a bottom portion of the back plate.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the phrase “door barricade” refers to a mechanism, which can secure and fortify an entryway door to withstand an attempt to gain entry by force. In the case of the present invention, it is easily engaged and works regardless of other conventional locking mechanisms. The present invention door barricade is a system that mounts both on the interior face of a room door (such as a classroom) and on the adjacent floor to the interior face of the door, preventing opening of the door by the connection of the door to the floor.

As used herein, the phrase “interior face of the door” refers to the side of a room door, such as a classroom, which faces the interior of the room. The exterior face is the opposite side of the door where a person would approach to gain entry, such as from the outside or from a hallway into a classroom.

As used herein, the phrase “adjacent floor” refers to the floor in the room closest to the interior face of the door. This can be clearly seen in the drawings and is clear from the description herein.

As used herein, the phrase “door interior face mounting plate” refers to a plate mounted against the interior face of the door to be barricaded. It acts to help attach the front plate to the door, and acts to prevent access to the system from the outside by going through the door. The mounting plate can be made from any sufficiently strong metal, or reinforced other material, to resist damage or breaking. It therefore can be steel (e.g., rolled steel), titanium, thick aluminum, or the like.

As used herein, the phrase “front plate” refers to a second plate which mounts onto the mounting plate and is designed in such a fashion that a vertical bolt is held between both the mounting plate and the front plate in a manner that allows the bolt to move up and down, as well as circumferentially in both directions (clockwise and counter-clockwise). It is also made of steel, thick aluminum, or other rigid, sturdy metal. The bolt can be held loosely, as shown in the Figures, by providing two or more wrap around positions that form a cylindrical opening between the two plates for operation. One could envision other means, larger, smaller, or more such bands to hold the vertical bolt in view of the drawings and description herein.

As used herein, the phrase “vertical bolt” refers to a metal pin or bar that is positioned vertically in-between the front plate and mounting plates. The bolt is held between the two plates such that it can move up and down between a down position and an up position and is therefore long enough to accomplish that feat. As shown in the Figures, the vertical bolt is longer than the two plates, but the plates could be longer and thus the bolt could be of similar height as the plates. The vertical bolt does not enter the receiving bolt. Again, the bolt can be steel, aluminum, or other rigid material or metal.

As used herein, the phrase “floor plate with a receiver hole” refers to a metal plate mounted into the adjacent floor by screwing, bolting, or the like, so that it is fixed in position. It has a hole in it, such as a round, rectangular, or slot-like hole, used as a receiving hole to receive the foot of the locking arm holding it in place on the floor.

As used herein, the phrase “locking arm” refers to an arm that is attached to the vertical bolt, such as by welding, such that it travels up and down and can rotate as the bolt travels from its up position to a down position. There is a locking foot at the bottom of the locking arm, such that when the bolt is in the lower position, the foot extends about to the floor. It is designed of a shape to fit into the hole in a receiver plate in the floor, and thus creates a locked position to barricade the door. In the down and locked position, the vertical bolt is kept from moving circumferentially. In one embodiment, the foot is of a shape that will fit into a slot (as shown in the Figures). Because there are the plates (and the door) behind the bolt, the locking arm and the bolt can only rotate 180 degrees from against the plates on one side to the other, as can be seen in the Figures. In general, the down position will have the locking arm essentially perpendicular to the plates and the interior door face since this is the strongest position for resisting force from the exterior face of the door. It can also rotate parallel to the plates when unlocked.

As used herein, the phrase “restrictor plate” refers to processes, ridges, tabs, or the like, that keep the arm from rotating circumferentially when it is in the down position. They can be on the locking arm, or on the front plate, or as desired. The restrictor plates are positioned as well to allow rotation circumferentially when in the up position, and to allow the locking arm to rotate against the mounting plate and keep it folded out of the way when not in use. In one embodiment, shown in the Figures, the locking arm only rotates against the right side and not the left side, but other versions are clearly possible in view of these drawings.

As used herein, the phrase “rest plate” refers to a tab or the like, to assist or rest the locking arm in the up position. In one embodiment, shown in the Figures, there is a plate mounted on the mounting plate and a slot on the arm which are matched, allowing the arm to rest on the rest plate and hold it in position when not in use.

As used herein, the phrase “door closed by a lever” refers to a standard commercial door as required in schools and businesses in the US. The lever is a device built into the door that fits in the adjacent door jamb to keep the door closed, though not locked. It is moved to an open position for opening the door in commercial settings by use of a lever handle, or a handicap device, or both, which are part of the latch.

As used herein, the phrase “egress” refers to being inside a room with the system of the present invention, engaging the lever to move the door to an open position, opening the door, and then leaving the room.

As used herein, the phrase “single motion” refers to simultaneously moving the door lever to the open position and lifting the vertical bolt to unlock the door barricade by operating the lever opening device to an open lever position. In previous devices, two motions were required, i.e., first unlocking the door barricade followed by engaging the lever opening device.

As used herein, the phrase “door opening device” refers to the standard commercial door with a latch, door handle, or the like, both of which can engage the door and move the door from a closed position to an open position. In addition, each door handle has an upper portion of cable attached to it with the lower portion of the cable attached to an upper position of the vertical bolt. Engaging the door handle also activates another device, i.e. the cable, in a manner that raises the bottom portion of the cable to lift the vertical bolt to the open position.

As used herein, the phrase “cable” refers to a flexible or inflexible wire, wire rope, braided wire, or the like having a top and bottom portion by which force is exerted to control or operate the door opening device and the cable top portion is rotated, lifted, or the like such that it lifts the bottom portion of the cable thus lifting the vertical bolt.

As used herein, the phrase “cable lifts the vertical bolt” refers to one end of a cable attached to the top of the vertical bar in a manner that when an upward force is placed on the cable, it raises the vertical bolt to the open position on the door barricade. This has to be done in conjunction with the opening of the door so that egress can be accomplished in one step. Accordingly, the top end of the cable is connected to the door knob or other door opening mechanism like a rotating cam, such as a lever cam or mortise cam, or the like, such that it creates an upward force that raises the vertical bolt at the same time as it opens the door. The drawings show two possibilities including two cams, but others are contemplated. In one embodiment, the top of the cable is wrapped around the door cam which lifts the cable when the door handle is used. The cams overlay the door handle Rosette on the interior face of the door and when the lever is engaged, the cam rotates, wrapping the cable around the cam and thus pulling the bottom of the cable opening the barricade. The cam is shaped to fit around the particular door lever.

As used herein, the term “cam” refers to a device associated with the door handle, which has a cord wrapped around it. When the door handle is operated, the bottom end of the cord is lifted up. Further clarity is seen in the Figures.

As used herein, the term “open-close cable” refers to a cable separate from the cable attached to the door lever to open or close the door barricade without opening the door. The device is connected to the vertical bolt in a manner identical to the door handle cable. A lift handle is on the top of the cable, which allows a user (especially handicapped) to lift the cable, moving the device to an open position; likewise, the open-close cable can rotate left or right moving the door barricade toward a closed or open position by use of the lift handle.

### DETAILED DESCRIPTION OF THE DRAWINGS

Examples of embodiments of the present invention are shown in the description of the embodiments shown in the Figures.

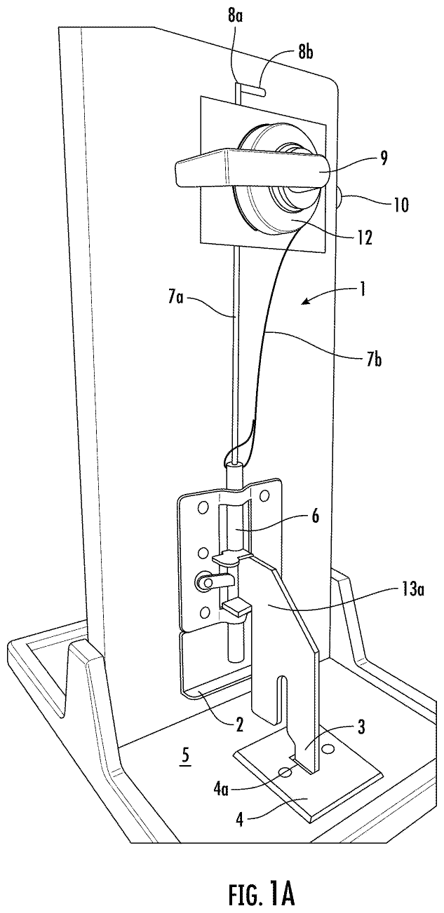

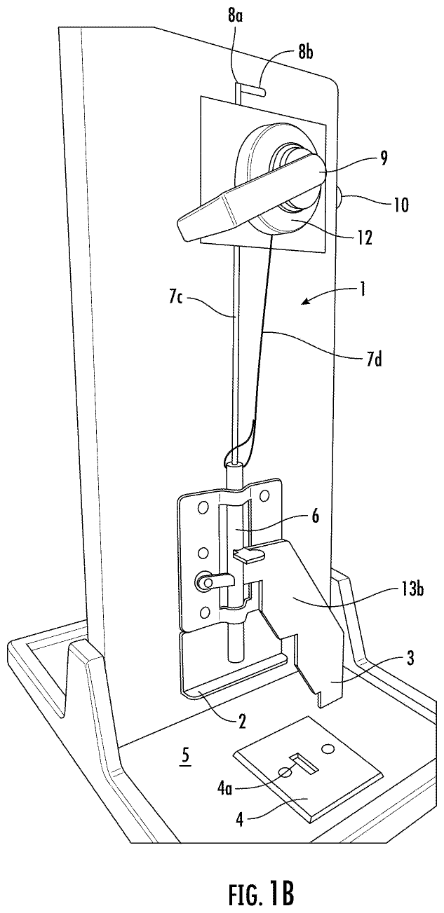

Now referring to the drawings, FIG. 1a is a perspective view an embodiment of the door barricade of the present invention in a closed (locked) position. In this view, interior face of door 1 has door barricade 2, wherein a locking foot 3 of lock in arm 13a is inserted into an opening 4a in plate 4 in the adjacent floor 5. Vertical bolt 6 is in a lowered position in this view, since it is directly connected to locking foot 3. Rod 7a and cable 7b are each connected to the vertical bolt 6 with rod 7a attached to the open-close handle 8a. The door handle 9 opens the door for the purpose of egress. As is shown in the following Figures, activation of the door handle 9 lifts cable 7b, which lifts the vertical bolt 6, thus opening the barricade at the same time as the door 10 is moved to an open position. In the embodiment, cable 7b is wrapped around the door lever back plate 12. Open-close handle 8a has handle 8b. Lifting and twisting the open-close handle can open or engage the barricade.

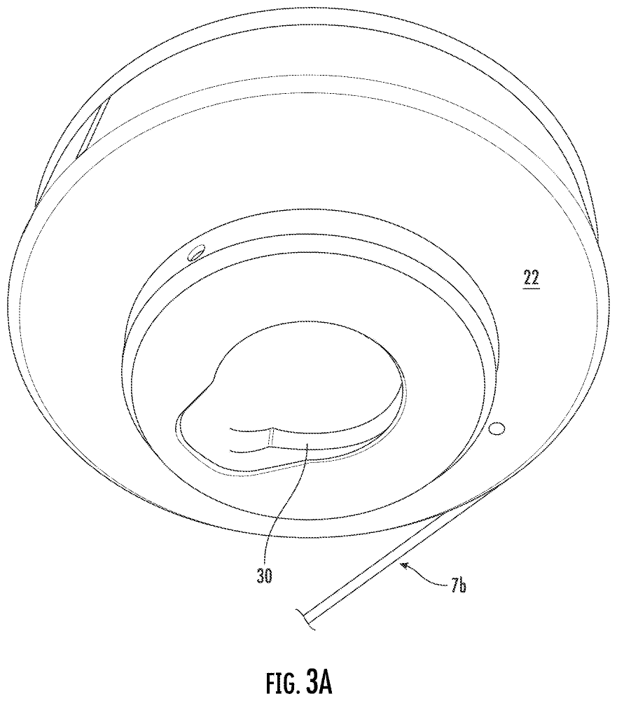

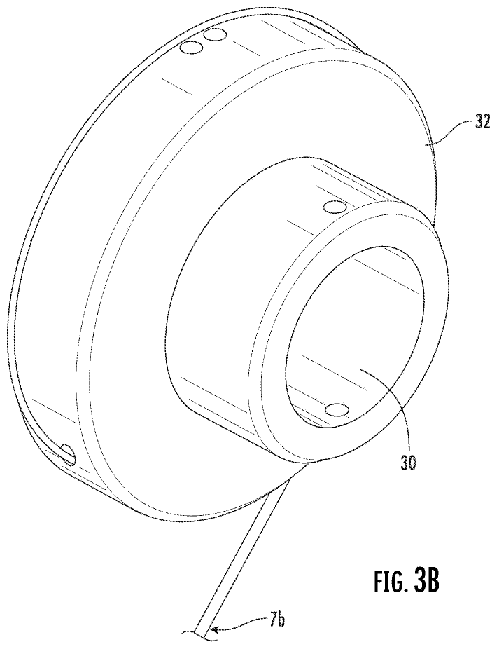

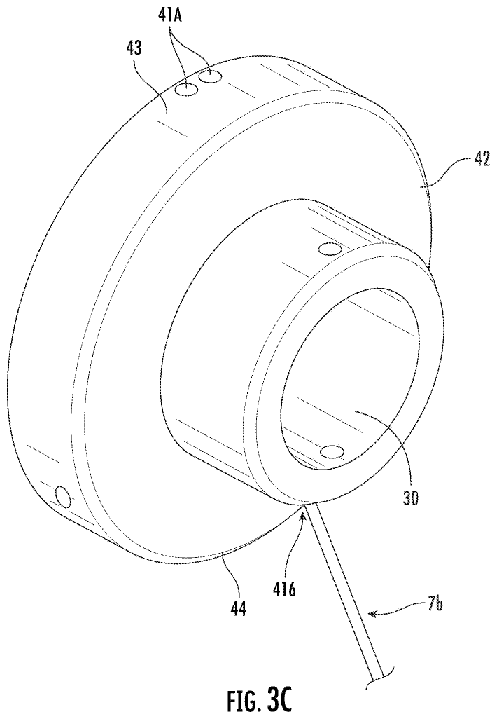

In FIG. 1b, the door barricade 2 is shown in the open position after either the door handle 9 is operated or the open-close handle 8b is raised and rotated and the door opening device has been activated, opening the door barricade 2. The door is opened using the door handle 9 and is not opened using open-close handle. Either open-close handle 8a or door handle 9 has been activated moving door 10 to an open position thus simultaneously lifting locking foot 3 by lifting cable 7d in a one-step door opening process. Shown in FIGS. 3a and 3b is cam 12 (lever 22 or mortise 32) which rotates when door handle 9 is operated and thus lifts the cable 7d unlocking the door barricade 2 by twisting the cable 7d around the round part of the cam 12. Cam 12 also rotates when handicap handle 8b is operated by being raised and rotated, thus lifting the rod 7c opening the door barricade 2 by twisting the cable 7d attached to a bottom part of the cam 12.

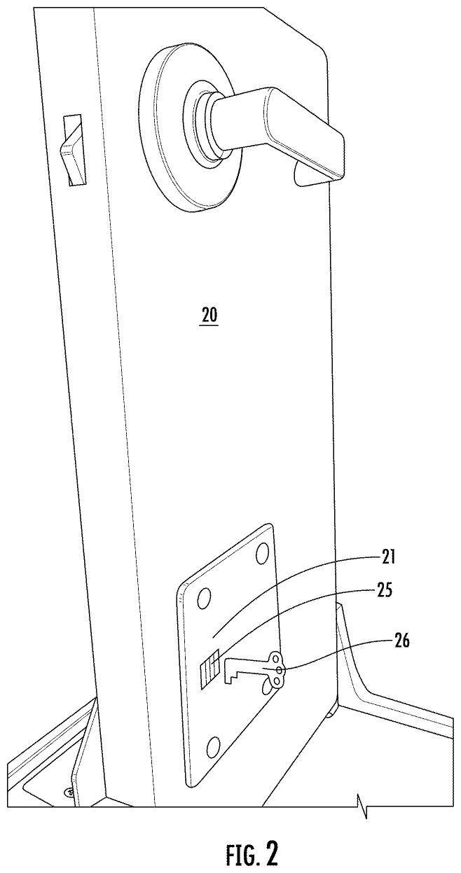

In FIG. 2, we see the exterior face of the door 20. As can be seen, there is no simple way to access the door barricade 2 on the interior face of the door. In order to make drilling through the door difficult, a steel plate 21 is shown mounted on the exterior face of the door directly opposite door barricade 2. In one embodiment, the exterior face has a key lock 25 opening/unlocking the barricade with key 26.

FIG. 3a is a perspective view of a back plate 22. The cable 7b is shown partially wrapped around back plate 22 such that when the back plate 22 is rotated counter-clockwise, it also rotates cable 7b and unlocks the door barricade 2 by pulling the vertical bolt 6 up to an open, unlocked position. The back plate 22 has opening 30 which fits around door handle 9 in a manner that pressing down on the door handle 9 to open the door 10 causes back plate 22 to rotate counter-clockwise and lift cable 7b. FIG. 3b is a perspective view of a mortise cam 32. Each of the cams is designed to fit on the particular type of door handle.

FIG. 3b is an alternate embodiment of a black plate 22 wherein cable 7b is attached to the back plate 22 at a bottom of the back plate. Thus the cable is only wound around the back plate when door lever is engaged.

FIG. 3c is a view of an alternative connection to cable 7b to the back plate 42. In this view, there are one or more holes 41a and 41b in back plate 42 either at the top 43 and bottom 44. Cable 7b can be attached to whichever holes 41a and 41b are at the bottom when the lever is attached (for left or right facing door handles). The cable 7b wraps around back plate 43 only when a handle is enraged 44.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like, apparent to those skilled in the art still fall within the scope of the invention as claimed by the applicant.

What is claimed is:

1. A door barricade system for a door having an interior face and an exterior face, wherein the door barricade is mounted for use on the door's interior face, which locks into an adjacent floor and has a straight vertical bolt having a lowered position when the door barricade is locked, wherein the vertical bolt is capable of moving up to an upper position to unlock the door barricade, the system having a dual cable system so the door can be unlocked and locked without opening the door comprising:
a) an open-close cable on the interior face of the door, a top portion of the open-close cable having a handle and a bottom portion of the open-close cable connected to a top position of the straight vertical bolt which, when engaged, moves the door barricade from a locked closed door position to an unlocked open door position or vice versa without opening the door; and
b) a door handle having a back plate, which rotates with the door handle for opening and closing the door, the door handle having a cable associated with the door handle, the cable having a top and bottom portion wherein the top portion is connected to the back plate and the bottom portion of the cable is connected to a top portion of the straight vertical bolt in a manner such that engaging the door handle to open the door causes the door handle cable to move the door to an unlocked position the cable wrapping around the back plate, which opens the door and unlocks the barricade by lifting the vertical bolt to an upper unlocked position.

2. The door barricade system according to claim 1 wherein the back plate is either a lever cam or a mortise cam.

3. The door barricade system according to claim 1 wherein the door handle cable is associated with the door handle and is wrapped around the back plate when the door is closed.

4. The door barricade system according to claim 1 wherein the door handle cable is attached to the bottom of the back plate when the door is closed.
